(19) United States
(12) Patent Application Publication
(10) Pub. No.: US 2012/0239445 A1
(43) Pub. Date: Sep. 20, 2012

(54) ANALYTICS VALUE ASSESSMENT TOOLKIT

(75) Inventors: Brian F. McCarthy, Atlanta, GA (US); Elliot Brook, Brooklyn, NY (US); Gregory A. Palmer, Apex, NC (US); Tiffany Brown, Atlanta, GA (US)

(73) Assignee: Accenture Global Services Limited, Dublin (IE)

(21) Appl. No.: 13/048,004

(22) Filed: Mar. 15, 2011

(51) Int. Cl. G06Q 10/00

(52) U.S. Cl. 705/7.11

(57) ABSTRACT

A computerized system to determine estimations for analytics capabilities includes a value driver determination module to determine key value drivers associated with the entity. The system also includes an analytics matching module to identify analytics capabilities that align to the key value drivers. An analytics valuation module estimates values for the matching analytics capabilities based on benchmarks and financial and operational data for the entity. A cost and capital determination module estimates costs and capital for implementing the matching analytics capabilities, and an analytics selector module determines benefits for the matching analytics capabilities based on the estimated values and the costs and the capital.

### BACKGROUND

Analytics is a way to uncover insights buried in data using advanced statistical methods. Analytics may be used to move beyond intuitive decision-making by bringing to light counter intuitive trends.

Analytics is quickly becoming a central strategy for many organizations moving forward to effectively compete in the market place. Analytics may be provided across many different types of industries. Furthermore, within each industry, different types of analytics may be available and applicable to different functions performed within the organization, such as marketing, supply chain, and human resources. Accordingly, organizations attempting to implement analytics as part of their competitive strategy often have to select from a plethora of different types of analytics. The availability of many potential analytics to implement makes the selection process difficult. Furthermore, an organization may need an integrated solution including multiple analytics for different organizational functions. Without a proper procedure to select the most effective analytics, it is difficult for the organization to prioritize and focus on the analytic areas that drive the most value.

### SUMMARY

A computerized system to determine estimations for analytics capabilities includes a value driver determination module to determine key value drivers associated with the entity. The key value drivers are based on at least one of industry standards, expert evaluation, and strategic priorities for the entity. The system also includes an analytics matching module to identify analytics capabilities from a plurality of analytics capabilities that align to the key value drivers. An analytics valuation module estimates values for the matching analytics capabilities based on benchmarks and financial and operational data for the entity. A cost and capital determination module estimates costs and capital for implementing the matching analytics capabilities, and an analytics selector module, executed by a computer system, determines benefits for the matching analytics capabilities based on the estimated values and the costs and the capital.

A method, which may be implemented by a computer system executing machine readable instructions includes determining value drivers associated with the entity; identifying analytics capabilities from a plurality of analytics capabilities that align to the value drivers and a desired outcome of the entity; determining benchmark data to estimate a potential benefit range for each matching analytics capability; and estimating value by a computer system for each matching analytics capability based on the corresponding potential benefit range for each matching analytics capability.

### BRIEF DESCRIPTION OF DRAWINGS

The embodiments of the invention will be described in detail in the following description with reference to the following figures.

FIG. 1 illustrates a system, according to an embodiment;

FIGS. 2-11 illustrate examples of screenshots that may be generated by the system, according to embodiments;

FIG. 12 illustrates a method for identifying analytics capabilities, according to an embodiment;

FIG. 13 illustrates a method for estimating values for analytics capabilities, according to an embodiment;

FIG. 14 illustrates a method for determining value proposition, according to an embodiment;

FIG. 15 illustrates a method for determining a roadmap, according to an embodiment; and

FIG. 16 illustrates a computer system, according to an embodiment.

### DETAILED DESCRIPTION

For simplicity and illustrative purposes, the principles of the embodiments are described by referring mainly to examples thereof. Also, the embodiments may be used in combination with each other. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the description of the embodiments.

### 1. Overview

According to embodiments, values and costs for analytics capabilities are estimated, and the estimates are used to identify optimum analytics capabilities to implement. Broadly, analytics is the process of analyzing data for making decisions. In many instances, statistical processes are used to make predictions to determine the most optimum decisions for an entity. There are many types of analytics, and each type of analytics that may be applied to an entity are referred to as an analytics capability. Examples of different analytics capabilities are pricing optimization analytics, workforce productivity analytics, marketing spend optimization analytics, demand forecasting analytics, etc. For example, with respect to pricing analytics, the pricing analytics may integrate real time data on customers' behaviors such as buying patterns and preferences for product and service attributes and other factors to identify the most optimum price to maximize sales for a particular good or service. The other types of analytics capabilities may determine optimizations in their categories. Different analytics capabilities may be available for different industries and functional departments within an organization.

Information for the entity and industry benchmarks may be used to identify optimum analytics capabilities for the entity. An entity may be a business, a government entity, any type of organization, an individual or group of individuals, etc. The entity may be any entity with responsibility and accountability to drive key elements of business performance. Determining the most optimum analytics capabilities to implement for the entity may include determining value drivers (also referred to as key value drivers) for the entity and linking analytics capabilities with value drivers based on benchmarks. Improvement potential is baselined and assessed by value driver and analytic capability, for example, based on entity performance and observed benchmarks. A system links these together to enable and maintain the causal link between each of the individual value drivers and the ultimate benefit the entity will target to achieve.

A financial value proposition report may be generated that presents a business case for implementing one or more analytic capabilities. A financial value proposition report, for example, indicates the costs, financial benefits (e.g., return on investment), cash flow summary and net present value over time for analytics capabilities. A roadmap report may be generated that indicates a value-based prioritization and sequencing of implementing multiple analytics capabilities over a period of time. These reports may indicate the financial information the entity needs to make decisions going forward, such as the additional cash flow that will be generated, and the pay-back period for the costs to implement. Also, these reports present an integrated financial view for implementing multiple analytics capabilities. These reports and other information generated by the embodiments help the organization focus on the most effective analytics capabilities to invest their funds which translates into outcomes that will be most beneficial for the organization.

### 2. System

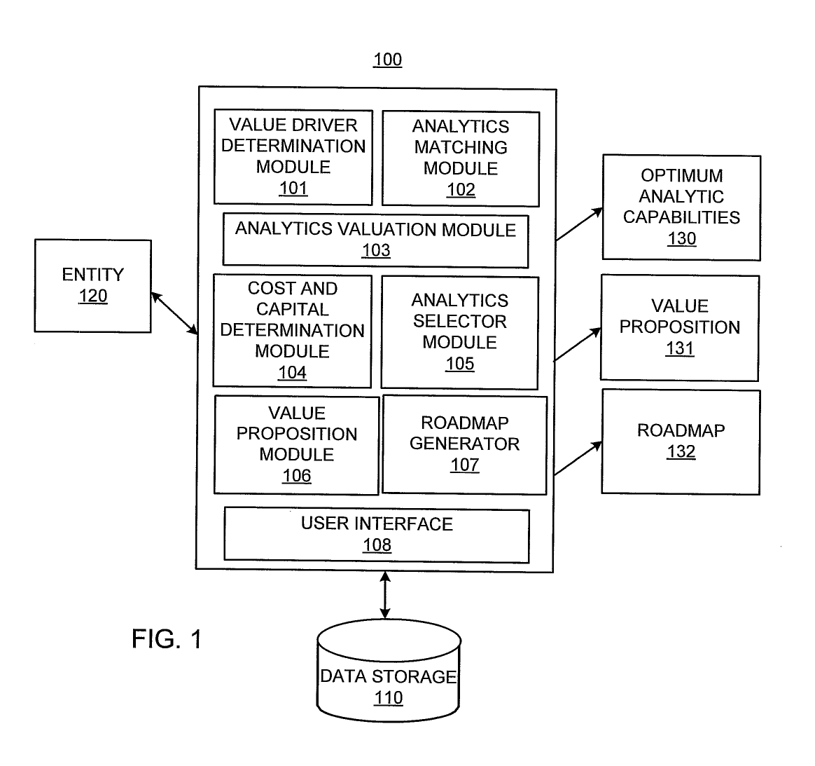

FIG. 1 illustrates a system 100, according to an embodiment. The system 100 estimates values of analytics capabilities for an entity 120, and identifies the optimum analytics capabilities 130 for the entity based on the valuations. A single entity is shown in FIG. 1 by way of example, however, multiple entities may connect to the system 100 to identify their optimum analytics capabilities.

The system 100 includes a value driver determination module 101, an analytics matching module 102, an analytics valuation module 103, a cost and capital determination module 104, an analytics selector module 105, a value proposition module 106 and a roadmap generator 107. The system 100 also includes a user interface 108, which may be a graphical user interface. An entity 120 may directly enter data and view or receive data via the user interface 108. The system 100 may also send and receive data from end user devices, servers or other systems. Data exchange may be via a network. The system 100 includes data storage 110, which may include a database or some other type of data management system for storing and retrieving data. The modules and other components of the system 100 may include software, hardware or a combination of hardware and software. Also, the system 100 may be implemented as a toolkit, which is a set of tools that may be implemented in software and/or hardware to perform the various functions described below.

The value driver determination module 101 determines value drivers for the entity and a category associated with the entity. The category may be based on industry type, good or service type, agency type, etc. A value driver may be a particular aspect of an entity that contributes to the overall value of the entity and the value driver may be a category of contributors impacting the value. Examples of value drivers are revenue growth, total sales, operational efficiency, costs of goods sold, staff costs, customer attrition, etc.

The value driver determination module 101 may determine multiple levels of drivers. For example, information for the entity 120 is determined. This may include a category for the entity 120, such as industry, and information describing a good or service provided by the entity 120. The information may be provided by the entity 120, for example, via the user interface 108. From the information, a first set of value drivers are identified. These may be general value drivers. In one example, a set of first level value drivers are stored for different industries in the data storage 110. A set of first level identifiers are retrieved from the data storage 110 for the industry for the entity 120.

The information determined for the entity 120 may also include business processes, value drivers currently used by the entity 120, and metrics for determining value. Based on this information, the first level value drivers may be modified and second level value drivers may be identified that further describe the first level identifiers. For example, all the industry-specific first level value drivers retrieved from the data storage 110 may not be applicable or may not be used by the entity 120. A subset of the industry-specific value drivers may be selected as the first level value drivers by a user. Second level value drivers may be selected based on business processes and decision points used by the entity and data available for the entity. Second level value drivers may be selected by a user from a stored set of value drivers. The value drivers may be provided via drop-down menu for selection. In one example, costs of goods sold may be a first value driver. The business processes for the entity 120 indicate that the entity closely tracks staffing and manufacture costs, costs of supplies and inventory drivers. These costs and other drivers may be provided as second or third level drivers.

The multiple levels of drivers may be referred to as a value driver tree. The tree includes first level or general value drivers at its highest level. Each lower level provides value drivers that further describe its parent value drivers. The tree may also include metrics for measuring the value drivers. The value driver determination module 101 organizes the value drivers as a value driver tree, which may be used to determine other calculations for estimating value.

The analytics matching module 102 identifies analytics capabilities from a plurality of analytics capabilities that match input value drivers. For example, the data storage 110 includes an analytics capabilities library that includes available analytic capabilities, the description of the capabilities and the stated benefits. An analytics capability description may include a brief description of the analytics capability. The description may identify one or more categories and value drivers for the analytics capability that can be matched with a category and value drivers for an entity. The description may also identify information needed by the analytics capability to execute, such as type and amount of historic data needed to accurately perform the analytics. Also, the entity's needs are determined. Using the descriptions and the entity's needs, analytics capabilities are matched to the entity 120.

The analytics valuation model 103 determines values for analytics capabilities. For example, the analytics valuation model 103 determines values for the matching analytics capabilities for the entity 120 which are identified by the analytics matching module 102. In one example, the analytics valuation model 103 determines potential benefit ranges for the matching analytics capabilities and values for the matching analytics capabilities are estimated from the potential benefit ranges. A potential benefit range is an estimation of impact an analytics capability may have on the entity. Benchmark data is gathered from previous implementations of similar analytics. The benchmark data, which may be stored in the data storage 110, may indicate the amount of impact particular analytics had on an entity. This benchmark data may be based on industry or another category because different industries have different sensitivities to different analytics. A potential benefit range may be calculated from the benchmark data, and the benchmark data may be applied to financial and operational data for the entity to determine value proposition. The value proposition may include estimations of net present value and cash flow summaries and other financial information presenting a business case for implementing analytics.

For example, pricing analytics may be used to select the best price to optimize sales and profits. The benchmark data indicates that for the industry for the entity 120, pricing impacts sales from 0.5 to 1.5%. One or more of the percentages may be used as or may be used to determine the potential benefit range for the entity 120. Data provided by the entity 120 may be used to determine value. If total sales for the entity 120 are 1 million, then multiply by one or more values 0.5 to 1.5 to estimate value. Factors, such as seasonality, that can impact pricing and sales may be considered when determining value. Also, benchmark data and data from the entity 120 are determined for metrics in the value driver tree associated with the value drivers. Potential benefit ranges may be calculated for the metrics to determine value.

The cost and capital determination module 104, estimates costs for implementing analytics capabilities, which includes costs for the matching analytics capabilities identified by the analytics matching module 102. Estimated cost and capital are calculated using multiple factors. The factors may include technology costs, work force costs, overhead, developments costs, service fees, etc. Technology costs may include software licenses, computer hardware, and maintenance. Work force costs may consider people requirements and training and change management. Overhead may include equipment and other assets, and there may be development costs.

Benchmark data may be gathered from previous implementations to determine costs for each of the factors based on industry. The data is stored in the data storage 110 and used to estimate costs for the entity 120. Costs may be retrieved for each factor and summed.

Service fees may be associated with a service-based implementation rather than a project-based implementation. For example, the entity 120 may be able to subscribe to an analytics service provided by an analytics service provider. The service provider may provide a monthly or yearly fee or a per use fee for the analytics. Project-based implementation may include the entity 120 executing the analytics internally. This implementation may incur all or some of the cost factors described above. Service-based costs may be compared to project-based costs to identify the cheaper implementation. The cost of the cheapest implementation may be selected as the estimated costs for the analytics capability.

Complexity may be a factor for estimating costs for implementing an analytics capability. For example, a complexity value, such as low, medium, or high may be assigned to each of the analytics capabilities including descriptions in the data storage 110. The complexity may be determined through historic analysis of the time, costs and number of tasks required to implement an analytics capability. Also, complexity may be based on whether the entity 120 already has some of the technology, people, overhead, etc., that is needed to implement the analytics capability. In one example, the entity 120 may already execute pricing analytics, but the entity 120 wants to determine whether to continue executing the pricing analytics or execute different analytics or whether to upgrade the pricing analytics. Because of the existing implementation, the complexity is selected as low even if the complexity for pricing analytics may be medium or high in other situations. In one example, complexity may be used as a weighting factor. For example, the different complexities are assigned different weights which may be multiplied by the potential benefit ranges.

The analytics selector module 105 selects the analytics capabilities likely to generate the most value for the entity 120. The determination may be based on the estimated costs determined by the cost and capital determination module 104 and the estimated values determined by the analytics valuation module 103. From the costs and values, reports may be generated, for example, via the user interface 108 identifying the optimum analytics capabilities to implement. In one example, the analytics selector module 105 prioritizes matching analytics capabilities based on cost and value. The highest priority analytics capability may have the highest or one of the highest values and may be the cheapest or one of the cheapest to implement. A value proposition module 106 determines value proposition for analytics capabilities, and a roadmap generator 107 generates a roadmap for implementing one or more analytics capabilities. Value proposition and roadmap report are described in detail below.

The system and methods and reports described herein describe how to provide complex estimations with a large number of combinations of value drivers. The manner in which the data is provided, for example in the reports, allows a user to perform a specific task more efficiently, i.e. to analyze the various data and identify the most optimum analytics capabilities to implement, thereby decreasing the mental and physical effort required by the user in order to accomplish the task.

Reports generated by the system 100 may include graphical representations of a prioritization and a potential sequencing of the matching analytics capabilities based on the estimated costs and values to provide a visual comparison of the matching analytics capabilities.

Financial reports may also be generated. A report may include a financial value proposition generated by the value proposition module 106 indicating the costs, financial benefits (e.g., return on investment), cash flow summary and net present value over time for analytics capabilities. The report may present a business case indicating the financial information the entity needs to make going forward, such as the additional cash flow that will be generated, and the pay-back period for the costs to implement.

The reports may also indicate benefit ramping for the estimated values for the matching analytics capabilities based on the potential benefit ranges. Benefit ramping is an estimation of when the estimated value can be achieved. For example, pricing analytics are estimated to improve sales by 0.5% to 1.5%. Benefits ramping indicates an estimation over a time period of when that could be achieved. If the estimation is a 1.5% increase in sales over a 5-year time period, the benefit ramping may indicate an estimate of a percentage of the total increase that may be achieved for each year. As an example, the entity 120 is a fertilizer supplier, so the greatest increase in sales is estimated to be prior to the growing season. If the entity is global, the growing season may vary by region, so this information and other factors may be considered for the benefit ramping. A roadmap report may be generated by the roadmap generator 107 that indicates an optimum value-based plan for implementing one or more of the matching analytics capabilities over time based on the benefit ramping. Examples of various reports are described below.

The entity 120 or other users may make adjustments to data as needed. For example, the data storage 110 stores descriptions and other information about analytics capabilities. This information may be modified. Also, the entity 120 may provide and modify data regarding their financial information and other information they may provide to identify optimum analytics capabilities.

### 3. Screenshot Examples

One or more of the screenshots described below may include examples of screenshots for entering, viewing and managing data in the system 100. The screenshots, for example, are presented through the user interface 108. The information shown in the screenshots may be stored in the data storage 110.

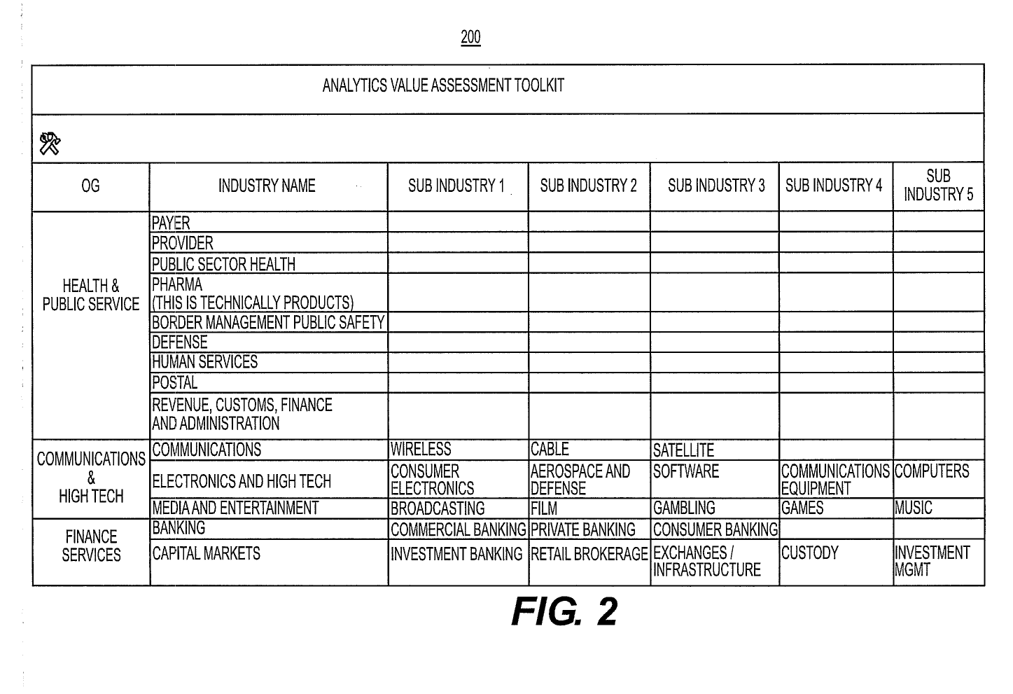

FIG. 2 illustrates an example of a screenshot 200 for entering categories for entities. The categories include a general types, industries and subindustries. For example, the general types include health and public service, communications and high tech, and financial services, and corresponding industries and some subindustries.

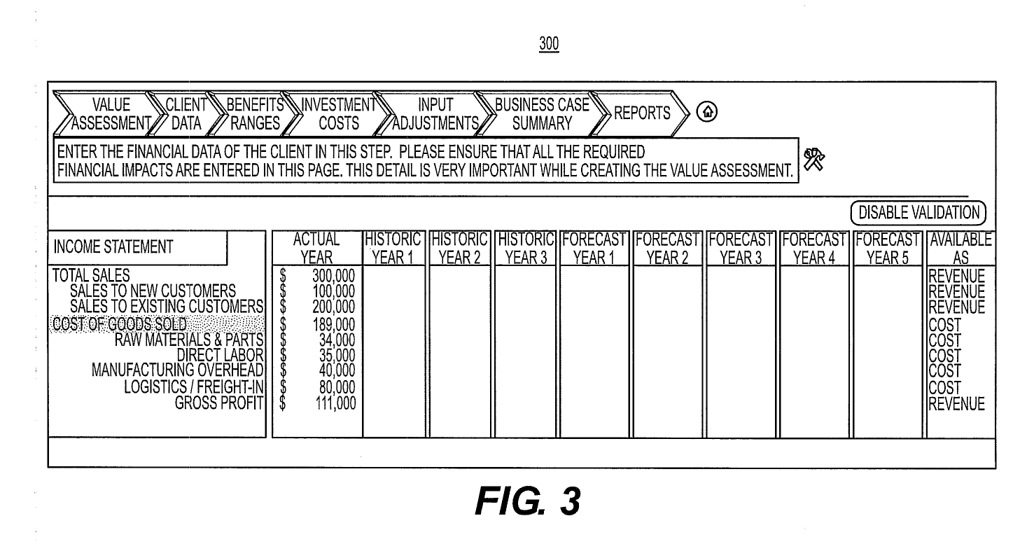

FIG. 3 illustrates an example of a screenshot 300 for entering financial data and operational data for an entity. The financial data may be categorized into revenue, cost, etc. Operational data may be associated with costs for operating and performing business functions. The financial and operational data may be used to determine value propositions and a roadmap for implementing analytics capabilities.

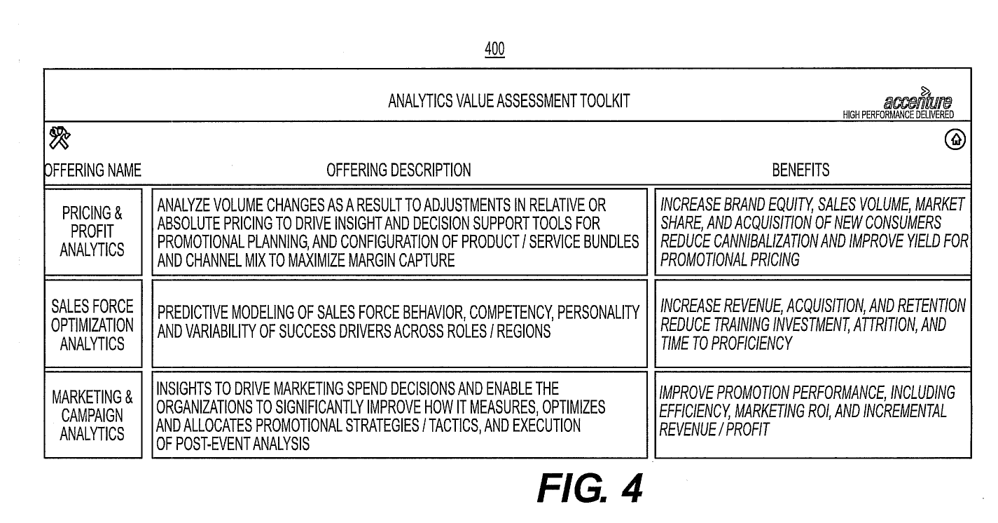

FIG. 4 illustrates an example of a screenshot showing descriptions for the analytics capabilities and benefits for the analytics capabilities. This information may be used for matching analytics capabilities with value drivers. The descriptions may include additional information not shown, such as categories for the analytics capabilities.

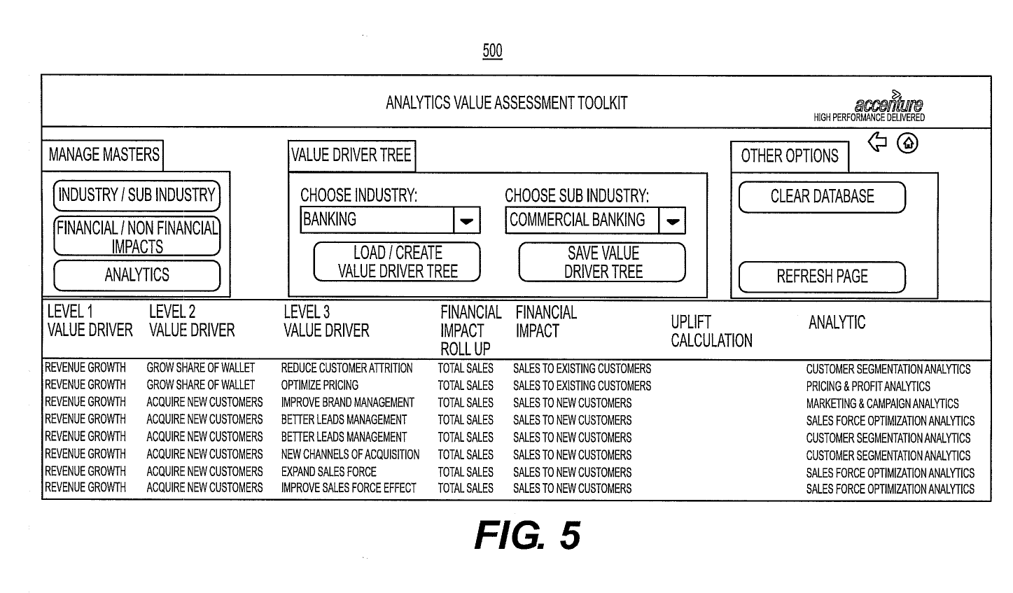

FIGS. 5-7 show examples of screenshots 500-700 including a value driver tree and show examples of valuation for matching analytics capabilities. FIG. 5 shows an example of a value driver tree for an entity in a commercial banking subindustry. The value driver tree includes multiple relationships. A relationship may include a relationship between drivers, a matching analytics capability and metrics, which may be associated with financial impact, financial impact rollup and uplift. For example, each row in the value driver tree shown in FIG. 5 represents a relationship. The first row includes a level 1 driver of revenue growth value driver, a level 2 grow share of wallet value driver, and a level 3 driver of reduce customer attrition. Share of wallet refers to selling or providing more services and products to an existing customer. The matching analytics capability for this relationship is customer segmentation analytics. Metrics for assessing the impact on value drivers 1-3 for customer segmentation analytics in this relationship are total sales and sales to existing customers. Sales to existing customers is rolled up to total sales.

The analytics valuation module 103 may use an uplift calculation to estimate the financial impact the customer segmentation analytics capability would have on sales to existing customers. The uplift calculation may be direct or indirect. A direct uplift calculation may multiply a potential benefit range by sales to existing customers. An indirect uplift calculation may also use the potential benefit range but applies a different calculation to determine the uplift.

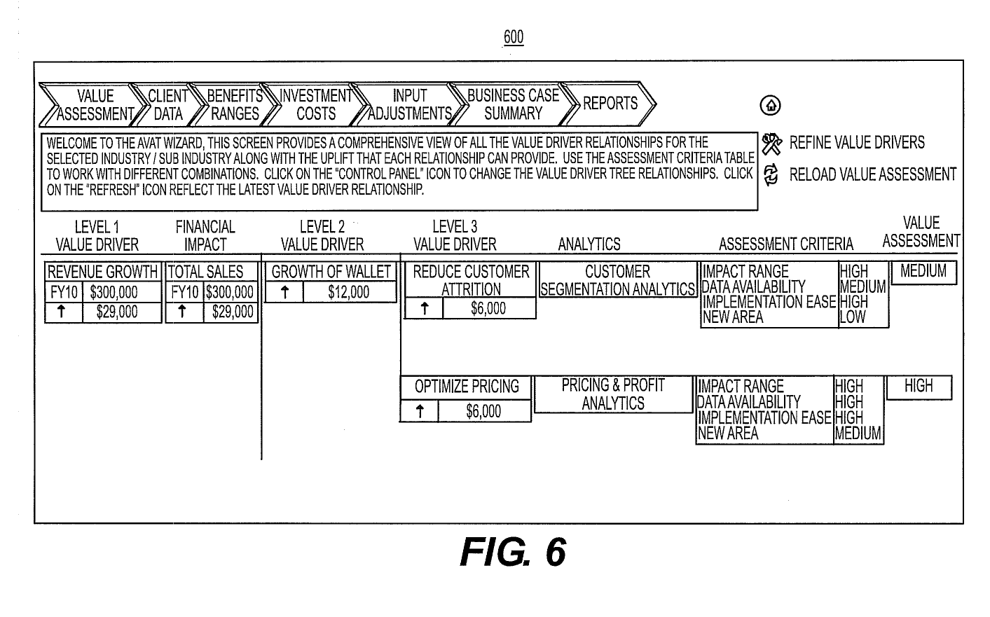

FIG. 6 shows examples of values determined by the analytics valuation module 103. For example, for the relationship shown in rows 1 and 2 from FIG. 5, values are shown for each of the value drivers. The values, for example, are estimated uplifts. The estimated uplifts with respect to sales to existing customers for the level 3 value drivers of reduce customer attrition and optimizing pricing is $6,000.00 for each. The uplifts may be totaled at various levels. For example, the total of $12,000.00 for the grow share of wallet level 2 value driver is $6,000.00 for reduce customer attrition plus $6,000.00 for optimizing pricing. The total uplift for the revenue growth is $29,000.00, which may include uplifts not shown. Uplift is one example of a financial value metric that may be used as values for value drivers in a value driver tree. Other metrics may be used.

As shown in FIG. 6, assessment criteria and a value assessment may be determined for matching analytics capabilities. The assessment criteria and the value assessment may be used to determine prioritization and sequencing for a roadmap as described in further detail below. Also, the assessment criteria and the value assessment may be used to determine a potential benefit range for estimating value and benefit ramping. Examples of assessment criteria may include impact range, data availability, implementation ease and impact to the organization. Other assessment criteria may be used, such as a financial value metric. For each of the assessment criteria, an assessment criteria value is determined. For example, as shown in FIG. 6, the assessment criteria value may be high, medium or low. A score may be calculated from each of the assessment criteria values to determine the value assessment for the analytics capability.

Impact range is an estimation of an overall impact of an analytics capability on value drivers. Impact range may be based on industry benchmarks, knowledge of the entity's business and other factors. The impact range and an assessment criteria value may be used to determine a potential benefit range for an analytics capability. Uplift calculations may be based on the potential benefit range determined from a selected impact range.

Data availability may be based on the data available describing the entity's financials and operational data. Implementation ease may be based on complexity to implement, and new area may be based on whether it is new area of the entity's business to optimize through analytics.

The value drivers, potential benefit ranges and other information may be determined by the system 100, may be selected by the entity 120 and/or may be determined by industry experts. In one example, the value driver determination module 101 and the analytics matching module 102 select the value drivers and matching analytics capabilities, and this information may be subsequently modified based on information from the entity 120 for valuation.

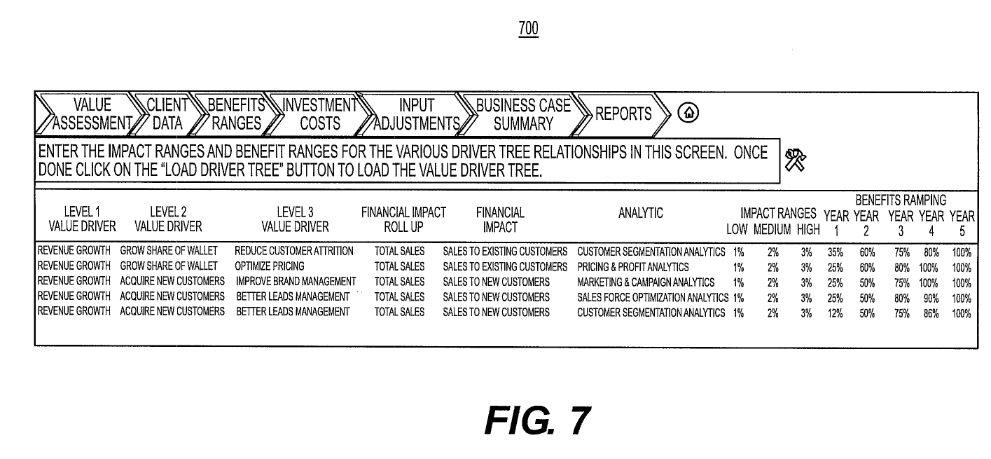

FIG. 7 shows impact ranges and benefit ramping for the value driver tree. By way of example, the impact range comprises 1%-3%. A potential benefits range may be determined from the impact range based on an assessment criteria value and used to calculate uplift. Also, by way of example, the benefit ramping shows the cumulative percentage for each year of a five year period for achieving the estimated total increase in sales. For example, it is estimated that 35% of the total will be achieved by the first year, 60% of the total will be achieved by the second year, and so on. These values may vary for different analytics capabilities and different industries and subindustries. The benefits ramping may be used to determine future cash flow summaries and to determine pay back periods for analytics investments.

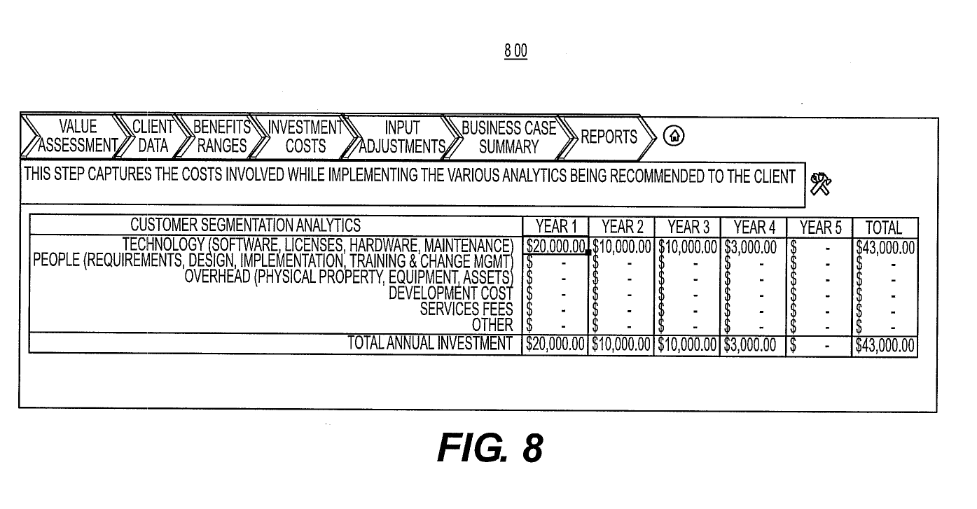

FIG. 8 shows a screen shot 800 including examples of cost estimates which may be determined by the cost and capital determination module 104 in the system 100. The cost estimates may be indicated by year and may be based on complexity of implementation.

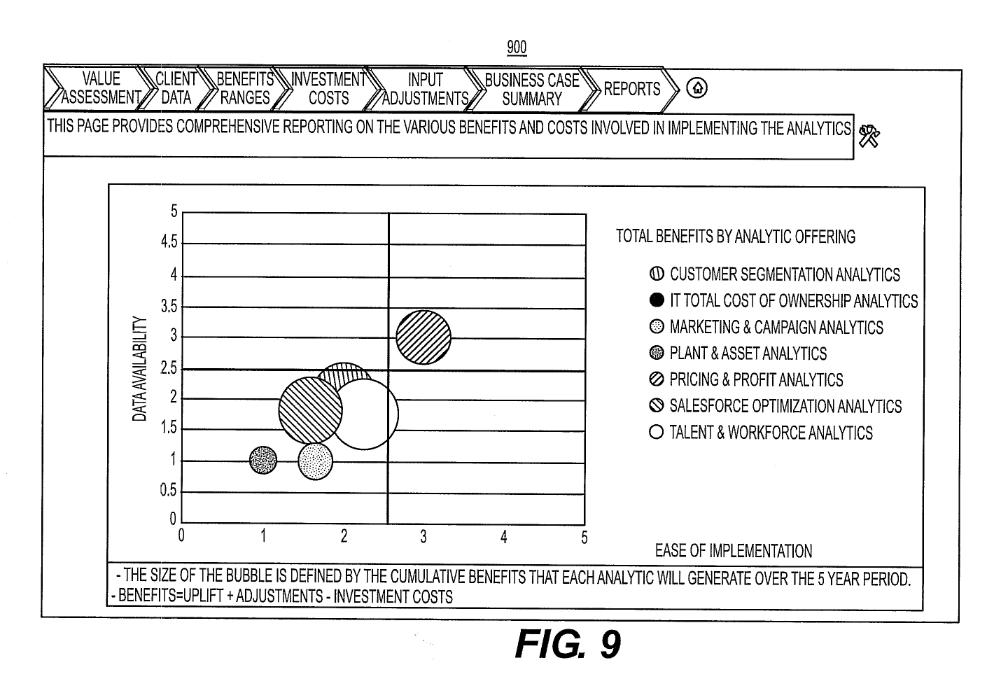

FIG. 9 shows a screen shot 900 including an example of a graphic visual representation which may be generated by the analytics selector module 105 of the system 100 to indicate benefits for matching analytics capabilities. Each circle represents a particular analytics capability. The size of the circle represents the benefit for each analytics capability. The benefit may be a cumulative benefit over a time period. For example, benefit=uplift+adjustments−costs. Adjustments may or may not be made and can include changes to uplift or other data to more accurately estimate benefits. In FIG. 9, the circle in the top right quadrant may be a most optimum analytics capability because it provides one of the highest benefits and is the easiest to implement and has the best data availability. This graphical representation provides an easy way to quickly compare and identify the most optimum analytics capabilities to implement.

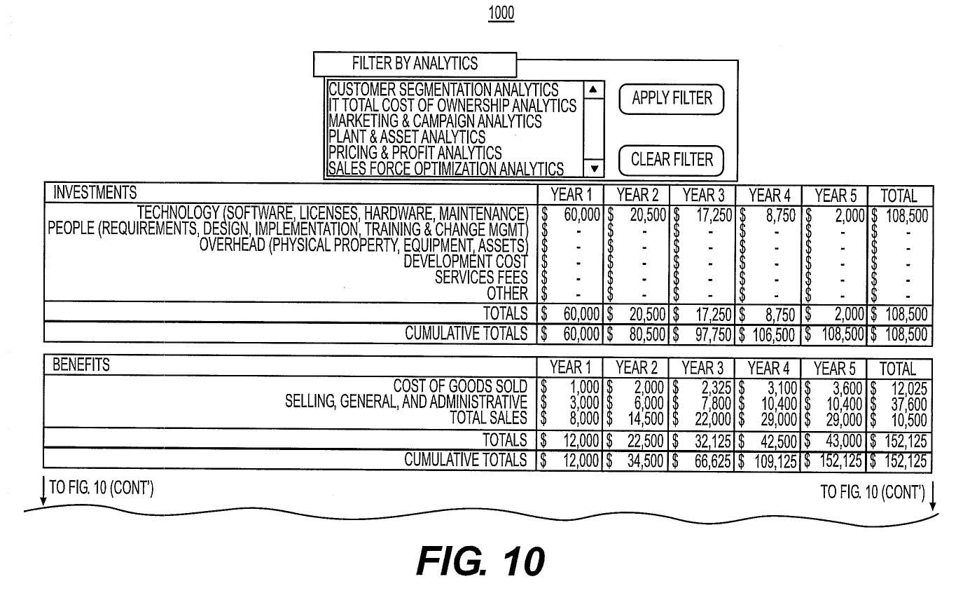

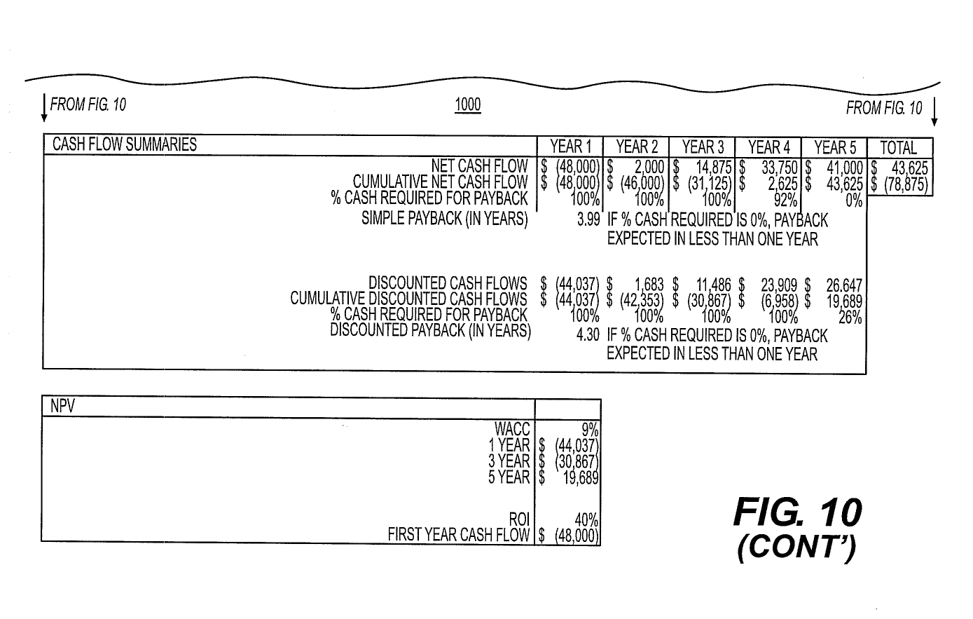

Other reports may be generated by the system 100 and presented, for example, via the user interface 108. FIG. 10 illustrates a screenshot 1000 showing an example of a value proposition report generated based on estimated valuations determined by the analytics valuation module 103 and based on historic financial information for the entity 120. The value proposition may include costs/investments, benefits, cash flow summary broken down by year. A net present value may also be estimated. The value proposition may be a cumulative representation of financial information for implementing all the matching analytics capabilities according to the sequence specified in the roadmap. Benefit ramping may be used to estimate a portion of the total benefits that may be achieved for each year.

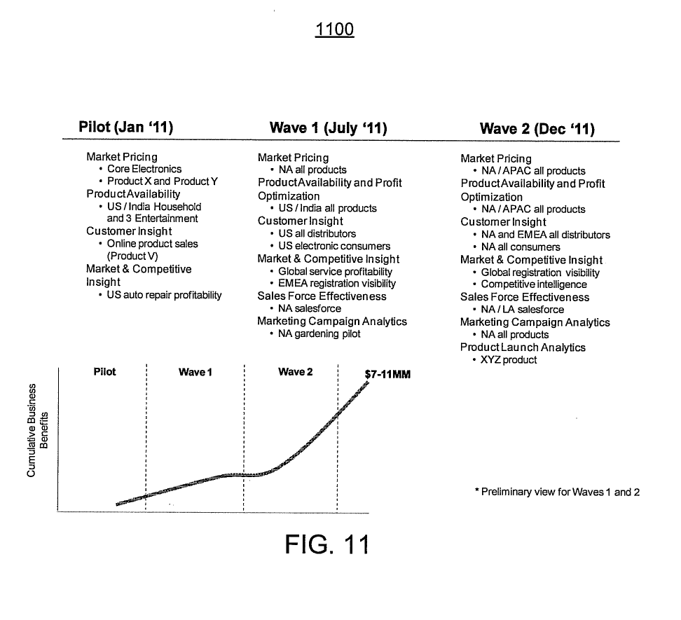

FIG. 11 illustrates a screenshot 1100 showing an example of a roadmap report. The roadmap indicates an optimum value-based plan for implementing analytics capabilities over time. For example, FIG. 11 shows cumulative benefits over time that may be achieved if matching analytics capabilities are implemented according to a sequence which may be determined based on assessment criteria and other factors. The sequence for implementing matching analytics capabilities is shown for each of the time periods, represented by Pilot (January 2011), Wave 1 (July 2011) and Wave 2 (December 2011). Under each time period, the analytics capabilities to be implemented for the time period are shown. For example, in Wave 1, in addition to one or more of the analytics capabilities implemented in the earlier time period shown as Pilot, Sales Force Effectiveness Analytics and Marketing Campaign Analytics are implemented. Then, in Wave 2, Product Launch Analytics may be implemented because a new product may be launching at near this point in time.

### 4. Methods

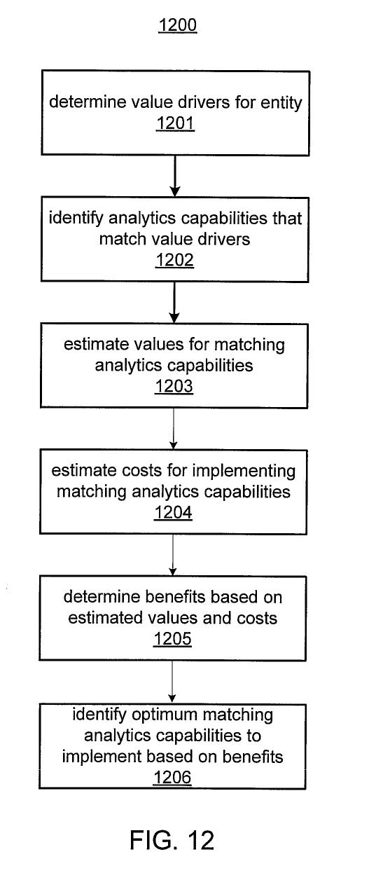

FIG. 12 illustrates a method 1200 for identifying optimum analytics capabilities, according to an embodiment. The steps of the method 1200 and of other methods described herein are described by way of example with the system 100. The methods may be performed by other systems. At step 1201, the value driver determination module 101 of the system 100 shown in FIG. 1 determines value drivers for the entity 120. The value drivers may be based on a category of the entity 120, which may be one or more industries and possibly subindustries. In one example, general level 1 value drivers are determined and lower level value drivers are determined based on data from the entity 120. Certain drivers may be predetermined based on the industry or subindustry for the entity 120. Other drivers may be determined based on drivers currently used by the entity 120 to evaluate performance and by evaluating existing business processes and decisions points. Value drivers may be selected for the entity based on alignment with strategic objectives for the entity.

At step 1202, the analytics matching module 102 identifies analytics capabilities that match the value drivers. For example, stored descriptions of analytics capabilities are matched with the input value drivers. The input value drivers matched with analytics capabilities are combined to create a value driver tree identifying relationships between value drivers and analytics capabilities. Matching may include determining analytics capabilities that are associated to the input value drivers and desired outcomes of the entity. The matching may not include exact matches but best or closest matches based on desired outcomes. The desired outcomes may include analytics capabilities that provide the best ROI or that best improve some aspect of a business or organization. Matching analytics are considered to be aligned to their value drivers.

At step 1203, the analytics valuation module 103 estimates values for the matching analytics capabilities. The estimated values may include an estimation of financial values that would be derived if the analytics capability were to be implemented. Implementing the analytics capability may include using the analytics to make a decision to achieve a goal, such as maximizing sales. The estimated values may include uplifts calculated based on potential benefit ranges.

At step 1204, the cost and capital determination module 104 estimates costs and capital needed for implementing the matching analytics capabilities. The cost and capital determinations may be calculated from historic analysis of data in the same industry or sub-industry. The cost and capital may be based on entity data, such as current infrastructure, current staffing, etc. In one example, the determinations may be calculated from historical analysis of data by a computer and then modified based on data specific to the entity by a user.

At step 1205, the analytics selector module 105 determines benefits based on the estimated values and costs for the matching analytics capabilities, and at step 1206 identifies the optimum matching analytics capabilities to implement based on the benefits. In one example, benefit=(uplift+adjustments)−costs. Adjustments may or may not be made and can include changes to uplift or other data to more accurately estimate benefits. In one example, an adjustment may modify cumulative benefits. For example, if two analytics capabilities A and B are implemented, the cumulative uplift may not be the sum of the uplifts for A and B but instead be a portion of the sum. Adjustments may be made to a cumulative benefit accordingly. The benefit ramping for the cumulative benefit may also be determined. The analytics selector module 105 may generate reports that may be used to compare and select the optimum matching analytics capabilities. The reports may indicate a subset of the matching analytics capabilities having the greatest values and lowest costs.

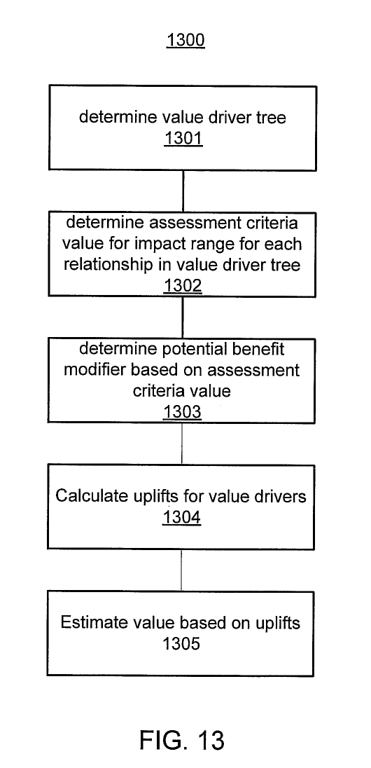

FIG. 13 illustrates a method 1300 for estimating values for analytics capabilities, according to an embodiment. The steps of the method 1300 may be performed to determine the estimated values for step 1203 of the method 1200. At step 1301, the value driver determination module 101 determines a value driver tree from the value drivers identified at step 1201. This may include prioritizing level 1 value drivers and creating relationships between multi-level drivers and matching analytics capabilities.

At step 1302, the value driver determination module 101 determines an assessment criteria value for impact range for each matching analytics capability. Examples of assessment criteria may include impact range, data availability, implementation ease and impact to the organization. A value of high, medium or low is selected for each criterion. The value may be selected by a user or calculated based on evaluating factors for each criterion. In one example, data availability is characterized as low, medium or high based on whether data is available for certain percentages of financial and operational metrics for the entity. In another example for impact to the organization, a user assesses the impact and selects a value. An average or weighted average may be applied to the values to determine an assessment criteria value for the analytics capability.

At step 1303, the value driver determination module 101 determines a potential benefit range based on the assessment criteria value. For example, as shown in FIG. 7, the impact range comprises 1%-3%. If “high” is determined, then the potential benefit range may be 3% or 2.1%-3%.

At step 1304, an uplift is calculated for each value driver for the analytics capability based on the potential benefit range. For example, 3% is the potential benefits range, and 3% is multiplied by revenue to calculate an estimated uplift.

At step 1305, uplifts are summed for each value driver associated with an analytics capability. For example, a customer segmentation analytics capability may have multiple relationships, such as shown in the multiple rows for customer segmentation analytics in FIGS. 5 and 7. The uplifts are summed for total sales for all the rows for customer segmentation analytics to determine the estimated value for that analytics capability. The estimated values may be used to determine benefits for the analytics capabilities and prioritizing the matching analytics capabilities based on the estimated values and costs.

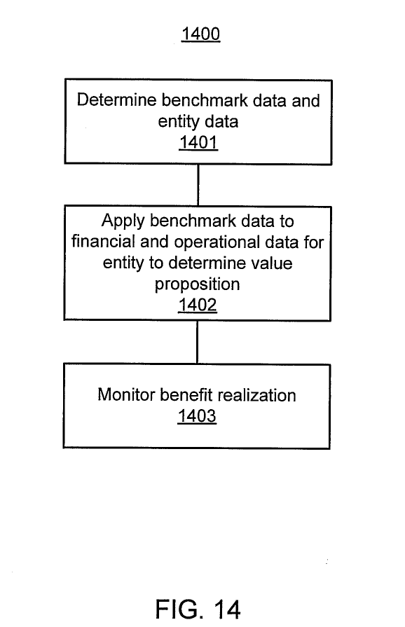

FIG. 14 illustrates a method 1400 according to an embodiment for determining value proposition for matching analytics capabilities. The matching analytics capabilities, for example, are determined from step 1202 of the method 1200 described above. An example of a value proposition report is shown in FIG. 10. The steps of the method 1400 may be performed by the value proposition module 106 shown in FIG. 1 or other modules.

At step 1401, benchmark and entity data are determined. Examples of entity data are shown in FIG. 3, which may be financial and operational data for the entity. This may include data related costs, sales, current cash flow, etc. Benchmark data may be gathered from previous implementations of similar analytics and stored in the data storage 110. The benchmark data may indicate the amount of impact particular analytics had on an entity. This benchmark data may be based on industry or another category because different industries have different sensitivities to different analytics. An impact range may be stored as part of the benchmark data.

At step 1402, the benchmark data may be applied to financial and operational data for the entity to determine the value proposition. The value proposition may include estimations of costs, benefits, net present value and cash flow summaries. For example, benchmark data may provide an estimate of costs (shown as investments) for an analytics capability. The benchmark data may be modified based on the entity's existing technology, workforce, and overhead to estimate costs. Also, cost benchmarks may be used to estimate a percentage of total cost that may be incurred for each year. In another example, benchmark data is used to determine a potential benefits range, which is used to determine benefit ramping for the benefits, as shown in FIG. 11. Current financial information may be used estimate total benefits. Similarly, cash flow summaries, including payback is calculated and shown. Net present value may also be estimated. For example, net present value equals cash receipts minus cash payments over a given period of time.

Information is provided below that may be included in the value proposition or other reports. A Total Enhancement to Revenue by Analytic Offering report provides an overview of the various enhancements to revenue items per analytics capability. The enhancements may be presented as cumulative benefits for a time period, such as 5 years, that the analytics capability will generate. An Enhancement to Revenue by Analytic Offering in Steady State report provides an overview of the various enhancements to revenue items per analytics capability based on final year (e.g., year 5) benefits. The base revenue is a total of all the final year financial impacts (e.g., revenue). Enhancement of each analytics capability is equal to the final year benefits that the analytics capability will generate. A Total Reduction to Cost by Analytics Capability Offering report provides an overview of the reduction to cost items per analytics capability. Reduction may be based on cumulative revenue the analytics capability will generate. A Reduction to Cost by Analytics Capability Offering in Steady State (Year 5) report provides an overview of the reduction to cost items per analytics capability based on year 5 benefits. A Benefits to Revenue Vs Cost By Year report provides the impact of the ramp-up on the benefits over a 5 year period. The report shows benefits separately for cost items and revenue items. A return on investment (ROI) Comparison report provides a comparison of individual analytics capability ROI Vs Overall project ROI. ROI=(Benefits−Investment Costs)/Investment Costs. A Simple Payback Comparison report provides a comparison of individual analytics capability payback vs overall payback. Payback Year=Year in which Benefits>Investment Costs.

At step 1403, benefit realization is monitored and tracked against the value proposition to determine the success of each specific analytic capability. If benefit realization (actual) does not match benefit estimates from the value proposition within tolerances, adjustments may be made to benefit estimates for future time periods. The same may be applied for cost and cash flow realizations when compared to corresponding estimates.

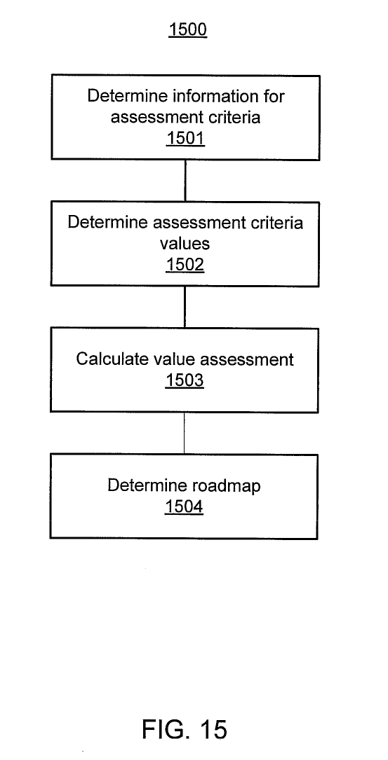

FIG. 15 illustrates a method 1500 for determining a roadmap, according to an embodiment. As indicated above, a roadmap may indicate a value-based prioritization and sequencing of implementing multiple analytics capabilities, which may be presented over a period of time. The roadmap may be presented via the user interface 108 to provide a visual representation of the prioritizing and sequencing. An example of a roadmap is shown in FIG. 11. The steps of the method 1500 may be performed by the roadmap generator 107 shown in FIG. 1 or other modules.

At step 1501, information for assessment criteria are determined for matching analytics capabilities. Examples of assessment criteria are shown in FIG. 6 and described above.

At step 1502, an assessment criteria value, such as low, medium or high, is determined for each assessment criteria. The assessment criteria value may be input by a user and can be based on benchmark data. For example, if customer segmentation analytics traditionally has had a high impact in the industry of the entity, the same “high” value may be given to the impact range assessment criteria for the entity. However, the entity's existing customer base may be considered when determining the assessment value, and may result in lowering the assessment value for impact range.

At step 1503, a value assessment is calculated for each of the matching analytics capabilities. The value assessment may be calculated based on a weighted average. For example, instead of weighting each assessment criteria value equally, the weight is adjusted based on whether the assessment criteria value is low, medium or high. Based on the weighted assessment criteria values, a value assessment is determined.

At step 1504, a roadmap is determined by prioritizing and sequencing the matching analytic capabilities. The prioritizing and sequencing may at least partially be determined from the value assessments. For example, analytic capabilities with higher value assessments may be implemented first. Other factors may also be considered when determining sequence for implementing matching analytic capabilities. For example, product launch analytics may be implemented later as product launch nears. Also, benefits ramping may be used to estimate benefits over time according to the sequence for implementation.

### 5. Computer System

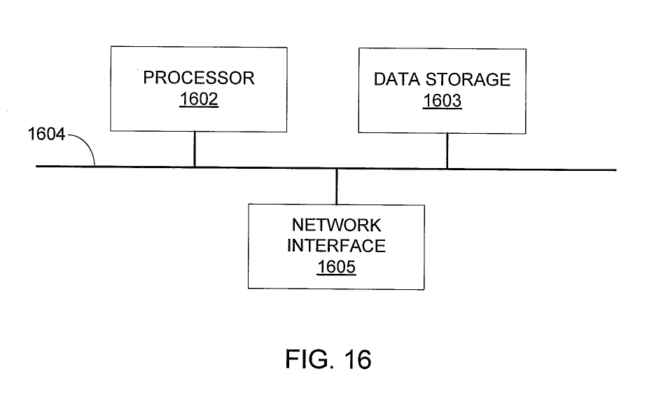

FIG. 16 shows a computer system 1600 that may be used as a hardware platform for the system 100. Computer system 1600 may be used as a platform for executing one or more of the steps, methods, modules and functions described herein that may be embodied as software stored on one or more computer readable mediums. The computer readable mediums may be non-transitory, such as storage devices including hardware.

Computer system 1600 includes a processor 1602 or processing circuitry that may implement or execute software instructions performing some or all of the methods, modules, functions and other steps described herein. Commands and data from processor 1602 are communicated over a communication bus 1605. Computer system 1600 also includes a computer readable storage device 1603, such as random access memory (RAM), where the software and data for processor 1602 may reside during runtime. Storage device 1603 may also include non-volatile data storage. Computer system 1600 may include a network interface 1605 for connecting to a network. It will be apparent to one of ordinary skill in the art that other known electronic components may be added or substituted in computer system 1600. Also, the components of the system 100 may be executed by a distributed computing system. In one example, the system 100 is implemented in a cloud system or other type of distributed computing system.

While the embodiments have been described with reference to examples, those skilled in the art will be able to make various modifications to the described embodiments without departing from the scope of the claimed embodiments. For example, the system and methods described herein are described with respect to determining estimations for analytics capabilities. However, the system and methods may be used to determine estimations for other services, which may include valuing other services that may be implemented to improve business processes and ROI.

What is claimed is:

1. A computerized system to determine estimations for analytics capabilities operable to estimate adjustments for functions performed by an entity, the system comprising:
a value driver determination module to determine key value drivers associated with the entity, wherein the key value drivers are based on at least one of industry standards, expert evaluation, and strategic priorities for the entity;
an analytics matching module to identify analytics capabilities from a plurality of analytics capabilities that align to the key value drivers;
an analytics valuation module to estimate values for the matching analytics capabilities based on benchmarks and financial and operational data for the entity;
a cost and capital determination module to estimate costs and capital for implementing the matching analytics capabilities; and
an analytics selector module, executed by a computer system, to determine benefits for the matching analytics capabilities based on the estimated values and the costs and the capital.

2. The system of claim 1, comprising:
a value proposition module to estimate value proposition for the matching analytics capabilities by determining the financial and operational data for metrics associated with the key value drivers; and applying the benchmark data to the financial and operational data for the metrics to estimate a value proposition range for the matching analytics capabilities.

3. The system of claim 2, wherein the value proposition comprises costs, financial benefits, cash flow summary and net present value over time for the matching analytics capabilities.

4. The system of claim 1, comprising:
a roadmap generator to determine a roadmap indicating a sequence for implementing the matching analytics capabilities over time based on prioritizing the matching analytics capabilities and benefit ramping for each matching analytics capability indicating how quickly benefit can be recognized from the matching analytic capability for the entity.

5. The system of claim 1, wherein the key value drivers comprise a value driver tree including a plurality of levels of value drivers for the entity identified based on a category associated with the entity and based on value drivers used by the entity, wherein each lower level key value driver further describes a general value driver at a highest level.

6. The system of claim 5 wherein the value driver tree comprises relationships between value drivers in the multiple levels and matching analytics capabilities and a financial value metric for each relationship.

7. The system of claim 6, wherein the analytics valuation module determines an assessment criteria value for impact range for each matching analytics capability; determines a potential benefit range based on the assessment criteria value; and calculates a value for the financial value metric based on the potential benefit range.

8. The system of claim 1, wherein the cost determination module estimates complexities for implementing the matching analytics capabilities; and determines the costs based on the complexities, timing and capital.

9. The system of claim 8, wherein the cost determination module estimates complexities by determining whether the matching analytics capabilities are to be implemented on a project basis, a subscription basis, internally sourced or externally sourced; and determining the costs and the complexities based on the determination.

10. The system of claim 1, wherein the analytics selector module generates a graphical representation of the benefits for the matching analytics capabilities to provide a visual comparison of the matching analytics capabilities over time.

11. An integrated method of determining value for analytics capabilities for an entity, the method comprising:
determining value drivers associated with the entity;
identifying analytics capabilities from a plurality of analytics capabilities that align to the value drivers and a desired outcome of the entity;
determining benchmark data to estimate a potential benefit range for each matching analytics capability; and
estimating value by a computer system for each matching analytics capability based on the corresponding potential benefit range for each matching analytics capability.

12. The method of claim 11, comprising:
determining entity financial and operational data for metrics associated with the value drivers; and
applying the benchmark data to the entity data to estimate value proposition for the matching analytics capabilities.

13. The method of claim 12, wherein the value proposition comprises costs, financial benefits, cash flow summary and net present value over time for the matching analytics capabilities.

14. The method of claim 13, comprising monitoring benefit realization overtime to determine the entity's success for achieving the financial benefits in the value proposition.

15. The method of claim 12, comprising:
determining costs for implementing each matching analytics capability;
determining a benefit based on the costs and the value for each matching analytics capability; and
determining a benefit ramping for each matching analytics capability based on how quickly the benefit can be recognized for the entity.

16. The method of claim 15, comprising:
applying assessment criteria to prioritize the matching analytics capabilities;
determining a roadmap indicating a sequence for implementing the matching analytics capabilities over time based on the prioritized analytics capabilities and the benefit rampings.

17. The method of claim 11, wherein the value drivers are selected for the entity based on alignment with strategic objectives for the entity.

18. The method of claim 11, wherein determining value drivers comprises:
identifying a plurality of levels of value drivers for the entity based on a category associated with the entity and value drivers used by the entity, wherein each lower level value driver further describes a general value driver at a highest level.

19. The method of claim 18, comprising:
determining relationships between value drivers in the multiple levels and matching analytics capabilities; and
determining a financial value metric for each relationship.

20. The method of claim 19, wherein estimating values for the matching analytics capabilities comprises:
determining an assessment criteria value for impact range for each matching analytics capability;
determining a potential benefit range based on the assessment criteria value; and
calculating a value for the financial value metric based on the potential benefit range.

21. The method of claim 15, wherein determining costs comprises:
estimating complexities for implementing the matching analytics capabilities; and
determining the costs based on the complexities, timing and capital.

22. The method of claim 21, wherein estimating complexities comprises:
determining whether the matching analytics capabilities are to be implemented on a project basis, a subscription basis, internally sourced or externally sourced; and
determining the costs and the complexities based on the determination.

23. The method of claim 11, comprising:
generating a graphical representation associated with the values for the matching analytics capabilities to provide a visual comparison of the matching analytics capabilities.

24. The method of claim 11, comprising:
gathering anonymous data from multiple entities regarding benefit realization for analytics capabilities for a specific industry; and
using the anonymous data for benchmarking the entities against each other.

25. A non-transitory computer readable storing machine readable instructions that when executed by a computer system performs a method of determining benefits for analytics capabilities for an entity, the method comprising:
determining value drivers associated with the entity;
identifying analytics capabilities from a plurality of analytics capabilities that align to the value drivers and a desired outcome of the entity;
determining benchmark data to estimate a potential benefit range for each matching analytics capability; and
estimating value by a computer system for each matching analytics capability based on the corresponding potential benefit range for each matching analytics capability.
